(19) United States
(12) Patent Application Publication
(10) Pub. No.: US 2008/0299423 A1
(43) Pub. Date: Dec. 4, 2008

(54) FUEL CELL SYSTEMS WITH MAINTENANCE HYDRATION

(76) Inventor: Arne LaVen, Bend, OR (US)

Correspondence Address: Dascenzo Intellectual Property Law, P.C., 522 SW 5th Ave, Suite 925, Portland, OR, 97204-2126, US

(21) Appl. No.: 11/755,145

(22) Filed: May 30, 2007

(51) Int. Cl. H01M 8/04

(52) U.S. Cl. 429/17; 429/22

(57) ABSTRACT

Fuel cell systems, and more particularly to fuel cell systems with fuel cell hydration provided during periods of inactivity by combining a fuel and an oxidant. In some embodiments, the systems may include at least one fuel cell with an anode region and a cathode region. The at least one fuel cell may be hydrated by disposing both a fuel and an oxidant in the anode region, the cathode region, or both the anode region and the cathode region, and, optionally, without generation of electrical output. In some embodiments, the systems may include a controller that controls combined delivery of a fuel and an oxidant to the at least one fuel cell. In some embodiments, the systems may deliver a mixture of the fuel and the oxidant to the at least one fuel cell after a period of fuel cell inactivity.

### FIELD OF THE DISCLOSURE

The present disclosure is directed generally to fuel cell systems, and more particularly to fuel cell systems with fuel cell hydration provided by combining a fuel and an oxidant during periods of inactivity.

### BACKGROUND OF THE DISCLOSURE

Fuel cell stacks are electrochemical devices that produce water and an electric potential from a fuel, such as a proton source, and an oxidant. Many conventional fuel cell stacks utilize hydrogen gas as the proton source and oxygen, air, or oxygen-enriched air as the oxidant. Fuel cell stacks typically include many fuels cells that are fluidly and electrically coupled together between common end plates. Each fuel cell includes an anode region and a cathode region that are separated by an electrolytic membrane. Hydrogen gas is delivered to the anode region, and oxygen gas is delivered to the cathode region. Protons from the hydrogen gas are drawn through the electrolytic membrane to the anode region, where water is formed. While protons may pass through the membranes, electrons cannot. Instead, the electrons that are liberated from hydrogen gas travel through an external circuit to form an electric current.

Fuel cell systems may be designed to be the primary and/or backup power source for an energy consuming assembly that includes one or more energy-consuming devices. When implemented as a backup, or auxiliary, power source for an energy-consuming assembly, the fuel cell system is utilized during times when the primary power source is unable or unavailable to satisfy the energy demand, or applied load, of the energy-consuming assembly.

The electrolytic membranes of some fuel cell systems, such as proton exchange membrane (PEM), or solid polymer fuel cell systems, generally need to have a proper level of hydration to allow the electrolytic membranes to function properly for generation of electrical output. During operation of the fuel cell system, water for membrane hydration is generated by electrochemical reaction. However, during periods of inactivity, which are common for fuel cell systems that are utilized as an auxiliary power supply, the electrolytic membranes tend to dry out. As a result, the ability of the fuel cell system to reliably provide power when needed may be reduced substantially. One approach to maintaining hydration is to operate the fuel cell system periodically during periods of inactivity in which the fuel cell system is not needed to supply power to satisfy an applied load from the energy-consuming assembly. However, this approach has associated costs due to the fuel consumed to generate this otherwise unneeded power output. Accordingly, new approaches are needed for maintaining the readiness of fuel cell systems during periods of inactivity.

### SUMMARY OF THE DISCLOSURE

The present disclosure is directed generally to fuel cell systems, and more particularly to fuel cell systems with fuel cell hydration provided during periods of inactivity by combining a fuel and an oxidant. In some embodiments, the systems may include at least one fuel cell with an anode region and a cathode region. The at least one fuel cell may be hydrated by disposing both a fuel and an oxidant in the anode region, in the cathode region, or both in the anode region and in the cathode region, and, optionally, without generation of an electrical output. In some embodiments, the systems may include a controller that controls combined delivery of a fuel and an oxidant to the at least one fuel cell. In some embodiments, the systems may deliver a mixture of the fuel and the oxidant to the at least one fuel cell after at least a predetermined period of fuel cell inactivity.

### BRIEF DESCRIPTION OF THE DRAWINGS

FIG. 1 is a schematic view of selected portions of an illustrative fuel cell system generating electrical output, in accordance with aspects of the present disclosure.

FIG. 2 is a schematic view of the fuel cell system of FIG. 1, hydrating fuel cells of the system without generation of electrical output, in accordance with aspects of the present disclosure.

FIG. 3 is a schematic view of an example of the fuel cell system of FIGS. 1 and 2 with a plurality of fuel sources, in accordance with aspects of the present disclosure.

FIG. 4 is a schematic view of an example of the fuel cell system of FIGS. 1 and 2 with a plurality of oxidant sources, in accordance with aspects of the present disclosure.

FIG. 5 is a schematic view of an illustrative power delivery network including the fuel cell system of FIGS. 1 and 2 and showing additional aspects and features that may be included in fuel cell systems, in accordance with aspects of the present disclosure.

FIG. 6 is a schematic view of selected aspects of an illustrative fuel cell, as may be used in fuel cell stacks according to the present disclosure.

FIG. 7 is a schematic fragmentary view of a plurality of fuel cells, as may be used in fuel cell stacks according to the present disclosure.

FIG. 8 is an exploded schematic view of a fuel cell, as may be used in fuel cell stacks according to the present disclosure.

FIG. 9 is a schematic view of an illustrative fuel cell system having distinct configurations for generating electrical output and for hydrating fuel cells during periods in which an electrical output is not being generated, in accordance with aspects of the present disclosure.

### DETAILED DESCRIPTION AND BEST MODE OF THE DISCLOSURE

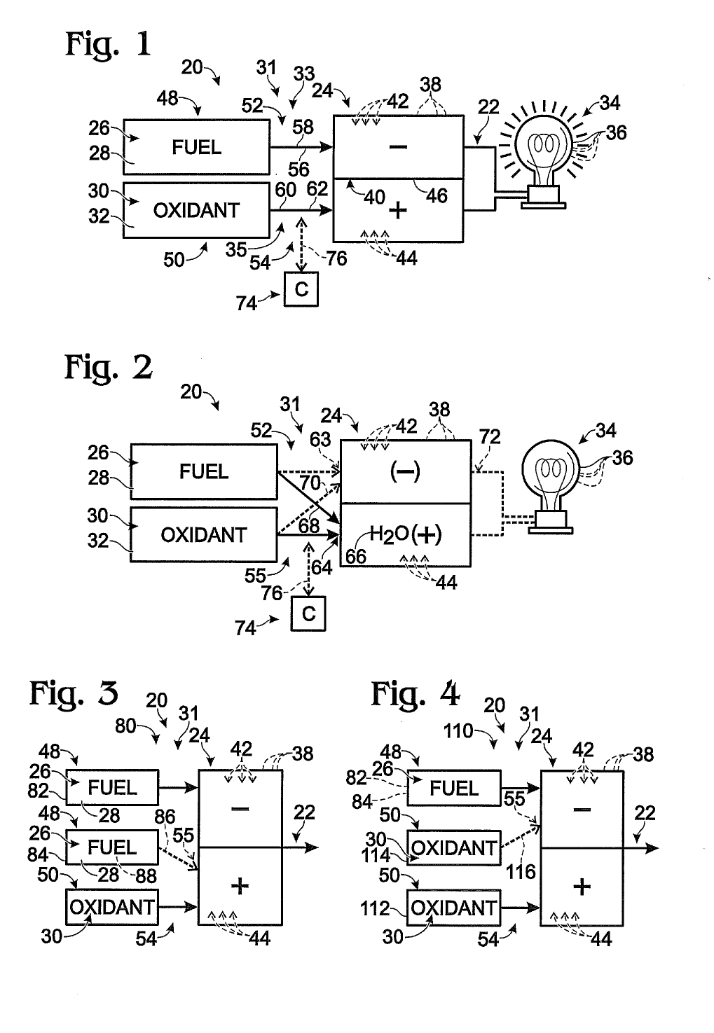

The present disclosure is directed generally to fuel cell systems with fuel cell hydration provided by combining a fuel and an oxidant during periods of fuel cell inactivity and/or periods in which the fuel cell system is not generating an electrical output with the fuel cells to be hydrated. Each fuel cell system may have distinct configurations in which (1) fuel and oxidant are delivered to respective (and separate) regions of at least one fuel cell, for generation of electrical output, or (2) to the same region(s) of the at least one fuel cell, for fuel cell hydration during periods in which the fuel cell is not generating an electrical output. FIGS. 1 and 2 illustrate examples of these distinct configurations.

FIG. 1 shows a schematic view of an illustrative fuel cell system 20 generating electrical output, which is indicated generally at 22. The fuel cell system may include at least one fuel cell stack 24 that is adapted to produce an electric current from a fuel 26, such as hydrogen gas 28, and an oxidant 30, such as oxygen gas (or air or another oxygen-containing gas that is suitable for use as an oxidant for the fuel cell stack) 32. The electric current 22 from the fuel cell stack may be used to satisfy an applied load from an energy-consuming assembly 34, which may include one or more energy-consuming devices 36. Electric current 22 may additionally or alternatively be referred to herein as the power output and/or the electrical output of the fuel stack.

Fuel cell stack 24 includes at least one fuel cell 38, but typically, a plurality of fuel cells 38. The fuel cells may be electrically connected to one another, such as in a series, and mechanically connected to provide fluid communication between the fuel cells. Although not required to all embodiments, the fuel cells may be arranged face-to-face with one another, and in one stack or two or more adjacent stacks, or, for example, in more complex geometrical arrangements.

Each fuel cell 38 may be structured to generate an electrical potential using discrete regions separated by a divider, or electrolytic barrier, 40 (which also may be referred to as an electron barrier). For example, the fuel cell may include an anode region 42 (the anode regions are collectively indicated schematically by “−”) and a cathode region 44 (the cathode regions are collectively indicated schematically by “+”), with respective negative and positive electrical biases or charges during fuel cell operation. Electrolytic barrier 40 may act to divide the fuel cell such that the fuel and the oxidant do not freely mix with one another, while permitting selective movement of positive charge through the barrier (and thus acting as an electron barrier). The barrier restricts contact, particularly substantial contact of the fuel and oxidant, meaning that the fuel and the oxidant remain (mostly) separated from each other. However, while not necessarily desired or required to all embodiments, in some embodiments the electrolytic barrier may permit a minor amount of leakage of the fuel and/or oxidant across the barrier while still serving as a barrier. The electrolytic barrier may be structured as a sheet- or membrane-supported electrolyte, for example, a proton exchange membrane 46 that permits passage of protons while blocking passage or flow of electrons, and as such may also be described as an ion exchange membrane.

Fuel 26 and oxidant 30 may be delivered to the fuel cells 38 in fuel cell stack 24 from at least one fuel source, or fuel supply, 48 and at least one oxidant source, or oxidant supply, 50. The fuel and oxidant may be delivered by the same or separate delivery systems 31. As such, in some embodiments, the fuel cell system may be described as including a reactant delivery system 31 that is adapted to deliver streams of fuel and oxidant from the respective fuel and oxidant supplies, or sources. In some embodiments, the reactant delivery system and/or the fuel cell system may be described as including a fuel delivery system 33 and/or an oxidant delivery system 35. When the fuel is hydrogen gas and the oxidant is air, the fuel delivery system may be referred to as a hydrogen delivery system and the oxidant delivery system may be referred to as an air delivery system.

The reactant delivery system and/or fuel cell system containing the fuel cells to be hydrated may be described as including, and/or being in fluid communication with, a suitable conduit structure, or conduit assembly, 52. Conduit assembly 52 provides at least one fluid conduit through which fuel (such as hydrogen gas) may be delivered from the fuel source to the anode regions of the fuel cell stack, and at least one conduit through which air or other suitable oxidant may be delivered from the oxidant source to the cathode regions of the fuel cell stack.

Furthermore, and as discussed in more detail herein, when it is desirable to hydrate fuel cells in the fuel cell stack after periods of inactivity, the conduit assembly and/or reactant delivery system is selectively adapted to deliver fuel to the cathode regions of the fuel cells to be hydrated and/or oxidant to the anode regions of the fuel cells to be hydrated. The reactant delivery system and/or conduit assembly may have a power-generating configuration, as schematically illustrated (especially with respect to energy-consuming assembly 34) in FIG. 1 and indicated at 54, with one or more fuel conduits, or fuel lines, 56 that carry a stream 58 of fuel 26 from fuel source 48 to anode regions 42, and one or more oxidant conduits, or oxidant lines, 60 that carry a stream 62 of oxidant 30 from oxidant source 50 to the cathode region.

Fuel source 48 and oxidant source 50 each may include any suitable mechanism(s) for storing, generating, and/or supplying fuel 26 and oxidant 30. Each source may be a closed system that is hermetically sealed or may be an open system that is open to the ambient atmosphere (such as an air supply that draws air from the ambient atmosphere). If structured as a closed system, the fuel/oxidant source may (but is not required to) include a vessel, such as a tank, for containing the fuel (or a fuel feedstock) or oxidant. The vessel may be capable of withstanding an increased internal pressure, such that the contents of the vessel may be pressurized above atmospheric pressure. The vessel may have any suitable position relative to the fuel cell stack. For example, the vessel may be positioned to provide an internal source, that is, a fuel/oxidant source inside a housing that holds both the vessel and the fuel cell stack, or the vessel may be positioned in a spaced relation to the fuel cell stack to provide an external source. The external source may be nearby, for example, in the same room and/or building or on the same grounds as the fuel cell stack, or the external source may be remote from the fuel cell stack, such as a fuel cell (or oxidant) source operated by a municipal supplier or a power company.

Oxidant source 50 may include any suitable structure for providing a sufficient quantity of oxidant (e.g., oxygen, air, or other suitable oxidant) to the fuel cell stack at a suitable pressure for use in the fuel cell stack. In some embodiments, the oxidant source may include a drive mechanism for urging oxidant to the fuel cell stack. The drive mechanism may include or be a blower, fan, or other lower pressure source of oxidant. Alternatively, or in addition, the drive mechanism may include or be a compressor, pump, or other source of higher pressure oxidant. In some embodiments, the oxidant source may be adapted to provide oxygen-enriched or nitrogen-depleted air to the fuel cell stack. In some embodiments, air for the fuel cell stack is drawn from the environment proximate the fuel cell stack, and in some embodiments, no drive mechanism is utilized to propel oxidant to the fuel cell stack (e.g., to provide an “open cathode,” or air-breathing,” design). Non-exclusive examples of suitable sources 50 of oxygen gas 32 include a pressurized tank of oxygen, oxygen-enriched air, or air; or a fan, compressor, blower or other device for directing ambient air to the cathode regions of the fuel cells in the fuel cell stack.

Fuel source 48 may provide generation and/or storage of the hydrogen gas or other fuel in any suitable form. The fuel may be in a molecular form suitable for use in the fuel cell stack or may be in a precursor form (a feedstock) that is processed to produce the fuel by changing the molecular structure of the precursor form. If stored as fuel rather than as a feedstock, the fuel may be in an unbound form (e.g., as a gas or liquid) that is available on demand or may be in a bound (e.g., adsorbed) form that must be released in order to use the fuel in the fuel cell stack. Examples of suitable fuel sources 48 for hydrogen gas 28 include a pressurized tank, a metal hydride bed or other suitable hydrogen storage device, a chemical hydride (such as a solution of sodium borohydride), and/or a fuel processor or other hydrogen generation assembly that produces a stream containing pure or at least substantially pure hydrogen gas from at least one feedstock.

In some embodiments, the fuel source may include a hydrogen-generation assembly adapted to produce a product hydrogen stream containing hydrogen gas 28 as a majority component. For example, the product stream may contain pure or substantially pure hydrogen gas. The hydrogen generation assembly may include a hydrogen-producing assembly, or fuel processing region, that includes at least one hydrogen-producing region in which hydrogen gas is produced from one or more feedstocks. The hydrogen generation assembly also may include a feedstock delivery system that is adapted to deliver the one or more feedstocks to the hydrogen-producing region in one or more feed streams. The feedstock delivery system may be adapted to deliver the feed stream(s) at a suitable condition and flow rate for producing the desired flow of hydrogen gas therefrom. The feedstock delivery system may receive the feedstocks from a pressurized source and/or may include at least one pump or other suitable propulsion mechanism for selectively delivering the feedstock(s) under pressure to the hydrogen-generation assembly. The hydrogen-producing region may be adapted to produce hydrogen gas as a primary, or majority, reaction product through any suitable chemical process or combination of processes.

Examples of suitable mechanisms for producing hydrogen gas from one or more feed streams include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Illustrative, non-exclusive examples of suitable carbon-containing feedstocks include at least one hydrocarbon or alcohol. Illustrative, non-exclusive examples of suitable hydrocarbons include methane, propane, natural gas, diesel, kerosene, gasoline and the like. Illustrative, non-exclusive examples of suitable alcohols include methanol, ethanol, and polyols, such as ethylene glycol and propylene glycol. It is within the scope of the present disclosure that the fuel processor may be adapted to produce hydrogen gas by utilizing more than a single hydrogen-producing mechanism.

In many applications, it is desirable for the hydrogen-generation assembly to produce at least substantially pure hydrogen gas. Accordingly, the hydrogen-generation assembly may include one or more hydrogen-producing regions that utilize a process that inherently produces sufficiently pure hydrogen gas, or the hydrogen-generation assembly may include suitable purification and/or separation devices that remove impurities from the hydrogen gas produced in the hydrogen-producing region. As another example, the hydrogen-generation assembly may include purification and/or separation devices downstream from the hydrogen-producing region. In the context of a fuel cell system, the hydrogen-generation assembly preferably is adapted to produce substantially pure hydrogen gas, and even more preferably, the fuel processor is adapted to produce pure hydrogen gas. For the purposes of the present disclosure, substantially pure hydrogen gas refers to hydrogen gas that is greater than 90% pure, preferably greater than 95% pure, more preferably greater than 99% pure, and even more preferably greater than 99.5% pure. Illustrative, non-exclusive examples of suitable fuel processors are disclosed in U.S. Pat. Nos. 6,221,117, 5,997,594, 5,861,137, and U.S. Patent Application Publication Nos. 2001/0045061, 2003/0192251, and 2003/0223926. The complete disclosures of the above-identified patents and published patent applications are hereby incorporated by reference for all purposes.

Reactant delivery system 31 may include any suitable mechanism(s) and/or structure(s) for carrying, guiding, restricting movement of, and/or driving fuel and oxidant between the fuel and oxidant sources and the fuel cell stack via conduit assembly 52. The reactant delivery system and/or conduit assembly may be considered distinct from the fuel source and/or the oxidant source, or may constitute a portion or all of one or both sources. The reactant delivery system thus may include any suitable combination of conduits, valves, and drive mechanisms (to drive valve operation and/or fluid flow), among others. Illustrative conduits may include one or more pipes, tubing, manifolds, channels formed in a substrate, and/or the like, among others. Each conduit may be branched or non-branched; linear, angular, curvilinear, or a combination thereof, among others; and circular, elliptical, polygonal, stellate, rosette, etc. in cross section.

FIG. 2 shows a schematic view of fuel cell system 20 hydrating fuel cells 38 of fuel cell stack 24. In particular, conduit assembly 52 is disposed in a hydrating configuration 55 in which fuel 26 and oxidant 30 are delivered to the same region of at least one, two or more, at least most, or all fuel cells 38 of fuel cell stack 24. For example, both the fuel and the oxidant may be delivered to one or more (or all) anode regions 42 (as suggested here by dashed flow arrows and indicated generally at 63), to one or more (or all) cathode regions 44 (as shown here by solid flow arrows and indicated generally at 64), or to both one or more anode regions and to one or more cathode regions, to form water 66 (and heat). Accordingly, conduit assembly 52 may include one or more hydration conduits, such as conduits 68 and 70, which provide a hydration path for fuel and/or oxidant delivery to the other anode/cathode regions. For example, in FIG. 2, conduit 68 carries fuel 26 to cathode regions 44 and conduit 70 (shown dashed to simplify the presentation) carries oxidant 30 to anode regions 42.

The fuel and the oxidant may be combined or otherwise mixed at any suitable position(s) along the conduit assembly. For example, the conduit assembly may be configured to combine the fuel and oxidant (e.g., a fuel stream and an oxidant stream) upstream of the fuel cell, such that a fuel-oxidant mixture is delivered to the fuel cell. Alternatively, or in addition, the conduit assembly may deliver a discrete fuel stream and a discrete oxidant stream to the fuel cell stack and/or to each fuel cell via distinct inlets such that the fuel and the oxidant first contact each other inside the fuel cell stack and/or fuel cell.

In some embodiments, when in hydrating configuration 55, the fuel cell(s) being hydrated and/or the fuel cell stack containing the fuel cell(s) being hydrated may generate no electrical output, as indicated by dashed output lines at 72 and by parentheses around the “+” and “−” symbols for the anode and cathode regions 42 and 44. Accordingly, fuel cell system 20 may be hydrated by combining fuel and oxidant, with or without energy-consuming devices 36 in electrical communication with, and/or applying a load to, the fuel cell system. The phrases “without generation of electrical output,” “does not generate electrical output,” and “no electrical output,” as used herein, mean that the corresponding fuel cell(s) and/or fuel cell system is not producing enough electrical output to meet the minimum power rating of most energy-consuming devices, for example, less than about 10%, 5%, 1%, 0.1%, or none (0%) of the power output (or maximum power output) of the fuel cell system in its power-generating configuration 54 (see FIG. 1). In some embodiments, the fuel cells to be hydrated may not produce any electrical output or may produce no more than approximately the open cell voltage of the fuel cells.

As used herein, the term “hydration cycle” may refer to the period in which water is generated in the anode or cathode of a fuel cell when the fuel cell is in a hydrating cycle after a period of inactivity. As discussed, this water is generated by selectively delivering both fuel and oxidant to the anode region, the cathode region, or both, of the fuel cell(s) to be hydrated. As used herein, “period of inactivity” refers to a period in which the fuel cell stack has not been used to generate an electrical output for more than a predetermined period of time, such as at least one day, one week, two weeks, one month, or more. “Period of inactivity” does not encompass a momentary interruption in the fuel cell stack being in a power-generating configuration, such as in which the hydration state of the fuel cell stack has not appreciably deteriorated from when the fuel cell stack was in a power-generating configuration.

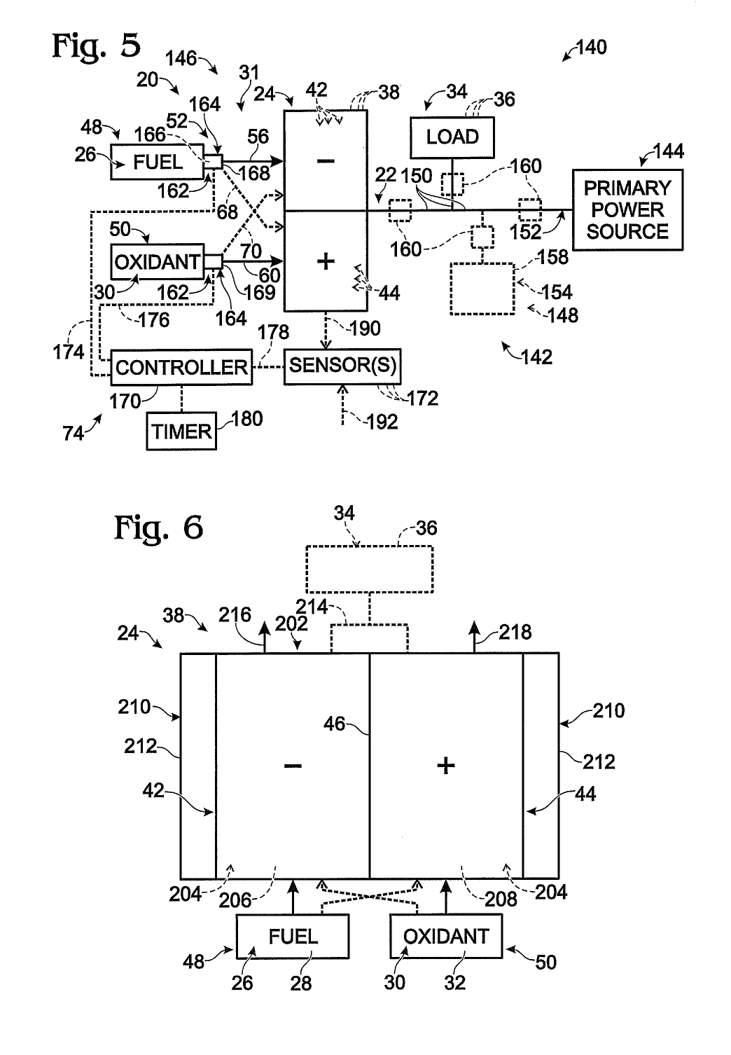

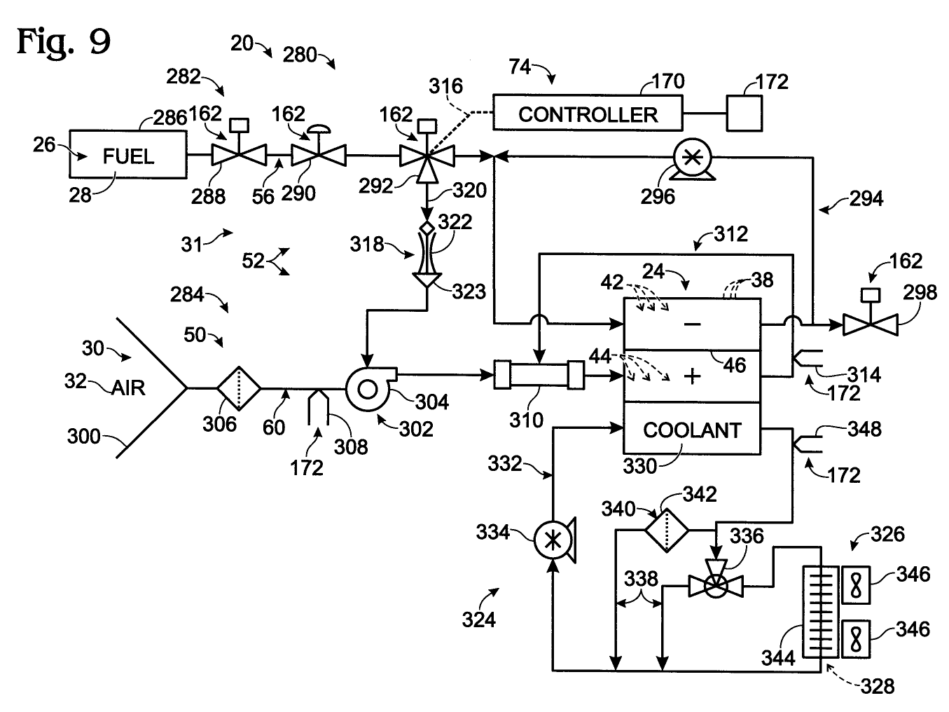

Fuel cell system 20 also may include a control system 74 that is in communication with and/or controls, as indicated at 76, any suitable aspects of the fuel cell system. For example, the control system may be operatively coupled to the conduit assembly or other suitable portion of the reactant delivery system to control placement, or otherwise configuring, of the fuel cell system 20 into and/or out of power-generating configuration 54, into and/or out of hydrating-configuration 55, and/or into and/or out of an idle (or inactive) configuration. The idle configuration may be any configuration that provides no delivery of fuel 26 (and/or oxidant 30) from fuel source 48 (and/or oxidant source 50) to fuel cell stack 24 (and fuel cells 38). Accordingly, with the fuel cell system in the idle configuration, there may be no, or no substantial, generation of electrical output (and/or electrical potential) by the fuel cell stack and no, or no significant, formation of water from reaction of the fuel and the oxidant. The control system may automate any suitable aspects of fuel cell system operation, such as selecting when hydration of the fuel cell stack is performed (i.e., started and/or stopped), for example, selecting times for placement of the fuel cell system into and out of the hydrating configuration. Further optional aspects of control systems for fuel cell systems and power delivery networks are described below in relation to FIGS. 5 and 9.

FIG. 3 shows a schematic view of an example 80 of fuel cell system 20 generating electrical output 22. Fuel cell system 80 may have at least two distinct fuel sources 48, namely, primary fuel source 82 and secondary fuel source 84. In power-generating configuration 54, primary fuel source 82 and oxidant source 50 may deliver fuel 26 and oxidant 30, respectively, to anode regions 42 and cathode regions 44 of fuel cells 38, as described above in relation to FIG. 1. However, in hydrating configuration 55, secondary (hydrating) fuel source 84 may deliver a stream of fuel 26 via a conduit(s) 86 to the same region(s) that oxidant source 50 delivers a stream of oxidant 30. For example, here, fuel and oxidant both are delivered to cathode regions 44 in the hydrating configuration. In other examples, fuel and oxidant both may be delivered to anode regions 42 or to both the anode regions and the cathode regions.

Fuel sources 82 and 84 may store and/or generate fuel in the same or different forms and in the same or different ways. For example, both of the fuel sources may produce fuel, in place, from a feedstock, both of the fuel sources may store the fuel itself, or one of the fuel sources may generate fuel from a feedstock and the other fuel source may store the fuel itself. In illustrative embodiments, primary fuel source 82 generates fuel 26, such as hydrogen gas 28, from at least one feedstock, and secondary (hydrating) fuel supply 84 stores fuel 26 (such as hydrogen gas 28 or a different fuel 88) in its active form (e.g., a vessel holding compressed fuel under pressure as a gas or liquid). Further optional aspects of fuel and oxidant sources are described below in relation to FIGS. 5 and 9.

FIG. 4 shows a schematic view of another example 110 of fuel cell system 20 generating electrical output 22 and thus being in a power-generating configuration 54. Fuel cell system 110 may have two or more oxidant sources 50, such as primary oxidant source 112 and secondary oxidant source 114. In power-generating configuration 54, fuel source 48 and primary oxidant source 112 may deliver fuel 26 and oxidant 30, respectively, to anode regions 42 and cathode regions 44 of fuel cells 38, as described above in relation to FIG. 1. However, in hydrating configuration 55, secondary (hydrating) oxidant source 114 may deliver a stream of oxidant 30 via a conduit(s) 116 to the same region(s) that fuel source 48 delivers a stream of fuel 26. For example, here, both fuel and oxidant are delivered to anode regions 42 in the hydrating configuration. In other examples, fuel and oxidant both may be delivered to cathode regions 44 or to both the anode regions and the cathode regions. Fuel for the power-generating configuration and for the hydrating configuration may be supplied by the same fuel source or may be supplied by distinct fuel sources 82 and 84, as described above in relation to FIG. 3.

FIG. 5 shows a schematic view of an illustrative power delivery network 140 including a fuel cell system 20 according to the present disclosure. FIG. 5 also illustrates a non-exclusive example of how fuel cell system 20 may be integrated into a power delivery network and further illustrates additional aspects and features that optionally may be included in fuel cell system 20, whether or not the fuel cell system is being used as a primary or backup power source.

Network 140 may include an energy-consuming assembly 34 and an energy-producing system 142. The energy-producing system may include a primary power source 144, an auxiliary (or backup) power source 146 (e.g., fuel cell system 20), and, optionally, an energy-storage power source 148.

Energy-consuming assembly 34 includes at least one energy-consuming device 36 and is adapted to be powered by energy-producing system 142, for to example, by primary power source 144, auxiliary power source 146, and/or battery 148. Expressed in slightly different terms, energy-consuming assembly 34 includes at least one energy-consuming device that is in electrical communication with the energy-producing system, as indicated at 150. The energy-consuming assembly may be powered by only one power source at a time or may be powered, in part, by two or more power sources at the same time. When powered by two or more power sources at the same time, the collective power output may be delivered to the energy-consuming assembly, optionally with distinct subsets of energy-consuming devices 36 being powered by distinct power sources.

Energy-consuming device(s) 36 may be electrically coupled to primary power source 144, auxiliary power source 146 (fuel cell system 20), and/or to one or more optional energy-storage devices 148 associated with network 140. Device(s) 36 may apply a load to a power source, such as fuel cell system 20, and may draw an electric current from the power source to satisfy the load. This load may be referred to as an applied load, and may include thermal and/or electrical load(s). It is within the scope of the present disclosure that the applied load may be satisfied by the primary power source, fuel cell system 20, and/or the energy-storage device. Illustrative examples of energy-consuming devices 36 may include vehicles (e.g., cars, trucks, recreational vehicles, motorcycles, etc.), on-board vehicle components, boats and other sea craft, lights and lighting assemblies, tools, appliances, computers, industrial equipment, signaling and communications equipment, radios, battery chargers, one or more households, one or more residences, one or more commercial offices or buildings, one or more neighborhoods, or any suitable combination thereof, among others.

The energy-consuming assembly is adapted to apply a load to energy-producing system 142. The load typically includes at least one electrical load. The primary power source is (nominally) adapted to satisfy that load (i.e., by providing a sufficient power output to the energy-consuming assembly), and the auxiliary power source is (nominally) adapted to provide a power output to at least partially, if not completely, satisfy the applied load when the primary power source is unable or otherwise unavailable to do so. These power outputs may additionally or alternatively be referred to herein as electrical outputs. The power and/or electrical outputs may be described as having a current and a voltage. Although not required, it is within the scope of the present disclosure that the auxiliary power source is adapted to immediately satisfy this applied load upon the primary power source being unable to do so. In other words, it is within the scope of the present disclosure that the auxiliary power source is adapted to provide energy-consuming assembly 34 with an uninterruptible power supply, or an uninterrupted supply of power. By this it is meant that the auxiliary power source may be configured to provide a power output that satisfies the applied load from energy-consuming assembly 34 in situations where the primary power source is not able or available to satisfy this load, with the auxiliary power source being adapted to provide this power output sufficiently fast that the power supply to the energy-consuming assembly is not, or not noticeably, interrupted. By this it is meant that the power output may be provided sufficiently fast that the operation of the energy-consuming assembly is not stopped or otherwise negatively impacted.

It is within the scope of the present disclosure that the load, which may be referred to as an applied load, may additionally or alternatively include a thermal load. The energy-consuming assembly is in electrical communication with the primary and auxiliary power sources via any suitable power conduit(s), such as schematically represented at 150 in FIG. 5. The primary power source and auxiliary power source may be described as having electrical buses in communication with each other and the energy-consuming assembly.

Energy-consuming assembly 34 may be adapted to be primarily, or principally, powered by primary power source 144. Primary power source 144 may be any suitable source of a suitable power output 152 for satisfying the applied load from the energy-consuming assembly. For example, primary power source 144 may include, correspond to, or be part of an electrical utility grid, another fuel cell system, a solar power system, a wind power system, a nuclear power system, a turbine-based power system, a hydroelectric power system, etc.

Auxiliary power source 146 may include at least one fuel cell stack 24 and therefore may be described as including or taking the form of a fuel cell system 20 that is adapted to produce a power output 22 that may be utilized to satisfy at least a portion, if not all, of the applied load from the energy-consuming assembly. Auxiliary power source 146 also may be referred to as an auxiliary fuel cell system or a fuel cell system that is adapted to provide backup power to the energy-consuming assembly. Additional illustrative, non-exclusive examples of auxiliary fuel cell systems, and components and configurations therefor, are disclosed in U.S. patent application Ser. No. 10/458,140, the complete disclosure of which is hereby incorporated by reference.

FIG. 5 schematically depicts that power delivery network 140 may, but is not required to, include at least one energy-storage device 148, such as a battery assembly 154. The battery assembly may include any suitable type and number of cells and may be referred to as a battery assembly that includes at least one battery 158 and an optional battery charger. Device 148, when included, may be adapted to store at least a portion of the electrical output, or power output, 22 from fuel cell stack 24. Illustrative, non-exclusive examples of other suitable energy-storage devices that may be used in place of or in combination with one or more batteries include capacitors and ultracapacitors or supercapacitors. Another illustrative example is a fly wheel. Energy-storage device 148 may be configured to provide power to energy-consuming devices 36, such as to satisfy an applied load therefrom, when the fuel cell stack is not able to do so or when the fuel cell stack is not able to completely satisfy the applied load. Energy-storage device 148 may additionally or alternatively be used to power the fuel cell system 20 during start-up of the system.

Power delivery network 140 may, but is not required to, include at least one power management module 160. Power management module 160 includes any suitable structure or device(s) for conditioning or otherwise regulating the electrical output produced by primary power source 144, auxiliary power source 146, and/or energy-storage power source 148, and/or being delivered to energy-consuming devices 36. Power management module 160 may include such illustrative devices as buck and/or boost converters, rectifiers, inverters, power filters, relays, switches, or any combination thereof, among others.

FIG. 5 also schematically shows illustrative mechanisms by which conduit assembly 52 may be placed in either a power-generating configuration or a hydrating configuration. FIG. 5 illustrates graphically that reactant delivery systems 31 according to the present disclosure (include those described and/or illustrated elsewhere herein) may include one or more flow-management devices 162 that are configured to regulate and/or restrict the flow of fuel and/or oxidant to fuel cell stack 24 via conduit assembly 52. Each flow-management device may be operable manually (i.e., requiring human effort or action), automatically (i.e., by machine without the need for triggering or implementing human effort or action), or both. If operable manually, the flow-management device may be operated by hand or by a drive mechanism that is controlled by direct human action.

Each device 162 may be structured to exert any suitable effect on the flow rate and/or flow direction of a fuel stream and/or oxidant stream between its respective source (48 and/or 50) and fuel cell stack 24. Accordingly, each device 162 may function to increase or decrease flow rate and/or to start or stop flow. Alternatively, or in addition, each device 162 may function to divert flow of fuel and/or oxidant to a distinct flow path. Illustrative flow-management devices may include a valve 164 and/or a drive mechanism 166. Any suitable type of valve may be used, such as stopcock, bleed, needle, shut-off, pinch, angle, ball, check (to restrict reverse flow), butterfly, diaphragm, flipper, globe, slide, gate, and the like.

In some embodiments, valve 164 may be operable to select a flow path for the fuel or oxidant. For example, FIG. 5 shows an illustrative, non-exclusive example of a fuel valve 168 that is operable to selectively direct fuel 26 to anode regions 42 via fuel conduit 56 or to cathode regions 44 via hydration conduit 68. Alternatively, or in addition, conduit assembly 52 may include an oxidant valve 169 that is operable to selectively direct oxidant 30 to cathode regions 44 via oxidant conduit 60 or to anode regions 42 via hydration conduit 70.

As discussed, fuel cell systems according to the present disclosure may, but are not required to, also include a control system 74. Control system 74 may include at least one controller 170 (e.g., a microprocessor) that selectively regulates the operation of the fuel cell system, such as by monitoring and/or controlling the operating state of various components and/or various operating parameters of the fuel cell system. Accordingly, the control system may include or be in communication with any suitable number and type of sensors 172 for measuring various system or ambient parameters or characteristics (such as temperature, pressure, flow rate, current, voltage, capacity, composition, etc.) and communicating these values to the controller. The control system may also include any suitable number and type of communication links for receiving inputs and for sending command signals, such as to control or otherwise adjust the operating state of the fuel cell system, or selected components thereof. The controller may have any suitable configuration, and may include software, firmware, and/or hardware components.

For the purpose of schematic illustration, a control system 74 with controller 170 is shown in FIG. 5 in communication, via communication links 174-178, with fuel valve 168, oxidant valve 169, and sensor(s) 172. Thus, controller 170 may provide automated control of when and/or how the conduit assembly is placed into distinct configurations, including power-generating and hydrating configurations, by controlling operation of valves 164 or other flow-management devices 162. However, alternatively or in addition, the controller may be in communication with any other portion of network 140, such as fuel source 48, oxidant source 50, power output 22, fuel cell stack 24, power management module(s) 160, primary power source 144, and/or energy-storage device 148, among others. Communication with any portion of network 140 may be mostly or exclusively one-way communication or may include at least two-way communication. In some embodiments, the control system may include a plurality of controllers in communication with each other. One of the controllers may be a primary, or central, controller that coordinates and controls the activity of one or more (or all) other controllers.

Control system 74 also may include a timer mechanism (a clock or timer) 180 in communication with controller 170. The timer mechanism may measure relative time (e.g., elapsed time since a particular event). An illustrative, non-exclusive example of a relevant time to be measured is the elapsed time since the fuel cells to be hydrated were last in either a power-producing configuration and/or a hydrating configuration. Illustrative, non-exclusive examples of such a time period include at least one day, one week, two weeks, a month, etc.

Alternatively, or in addition, the timer may measure or keep track of calendar time, that is, date and time of day. Controller 170 may operate reactant delivery system 31, such as one or more flow-management device(s) thereof, based on one or more time values measured by timer mechanism 180. For example, the controller may be programmed or otherwise configured to initiate or otherwise configure the fuel cell(s) and/or fuel cell system to a hydrating configuration in response to a preset elapsed time or preset start time measured by the timer. The elapsed time and/or start time may be preset, or configured, to initiate the hydrating configuration periodically with any suitable frequency of hydration, such as one or more times per day, one or more times per week, one or more times per month, etc. Accordingly, the fuel cell system may be programmed to perform automatic hydration operations, generally without generation of electrical output, on a regular or irregular basis when the fuel cell system is idle (not being used as an auxiliary power source). In some embodiments, one or more hydration cycles may be performed based on when the fuel cell system was last operated to generate power (i.e., in the power-generating configuration) or without regard to when the fuel system was used to generate power.

Controller 170 may be adapted to control operation of reactant delivery system 31, and/or the flow of fuel and/or oxidant through conduit assembly 52, based at least in part on one or more system or ambient characteristics measured by sensor(s) 172. The characteristics may relate to a condition of the fuel cell system itself, as represented by a sensor input 190 from fuel cell stack 24, and/or may relate to the environment outside, but generally near, the fuel cell system, as represented by ambient input 192 from the ambient environment. Illustrative characteristics may correspond to a system temperature, ambient temperature, a hydration level of the fuel cell stack, ambient humidity, and/or the like. Accordingly, sensor 172 may be a temperature sensor, a hydration sensor, a humidity sensor, or the like. Illustrative temperature sensors that may be suitable include thermistors, thermocouples, infrared thermometers, electrical resistance thermometers, mercury-in-glass thermometers, silicon bandgap temperature sensors, coulomb blockade thermometers, and the like. Illustrative hydration and/or humidity sensors that may be suitable include hygrometers, impedance sensors (e.g., measuring the impedance of the fuel cell stack or a portion thereof), electrolytic sensors, color indicators, spectroscopic sensors, or the like.

The controller's operations, such as the command signals generated thereby, may be provided by or otherwise correspond to an algorithm for determining when a fuel cell system should be placed into a hydrating configuration, and/or for how long the fuel cell system should be in the hydrating configuration. The algorithm may consider any suitable combination of ambient temperature, system temperature, sensed hydration level of a fuel cell or fuel cell stack, ambient humidity, length of time the fuel cell system has been idle (since the most recent hydration cycle and/or since generation of electrical output), and/or the like. In some embodiments, the algorithm may be used to select a time at which a hydration cycle instrument is started or stopped, that is, when the fuel cell system is placed into or out of a hydrating configuration, respectively. In some embodiments, hydration of the fuel cell system may be performed according to a preset value, such as a preset time interval between hydration cycles and/or since a fuel cell (or fuel cell stack or fuel cell system) was last in power-generating configuration 54. However, the preset time interval may (but is not required to) be adjusted based on other measured conditions and/or preset values, such as average ambient temperature, average ambient humidity, sensed hydration level of the fuel cell stack, a preset threshold temperature for performing a hydration cycle, a preset threshold hydration level for performing a hydration cycle, and/or the like.

The fuel cell stacks of the present disclosure may utilize any suitable type of fuel cell, including but not limited to fuel cells that receive hydrogen gas and oxygen gas as proton sources and oxidants. An illustrative, non-exclusive example of such a fuel cell is a proton exchange membrane (PEM), or solid polymer, fuel cells, although the maintenance hydration systems and methods of the present disclosure may be used with other types of fuel cells in which maintaining the hydration level of the fuel cell after periods of inactivity is desirable. For the purpose of illustration, an exemplary fuel cell 38 in the form of a proton exchange member (PEM) fuel cell is schematically illustrated in FIG. 6.

Proton exchange membrane fuel cells typically utilize a membrane-electrode assembly 202 consisting of an ion exchange, or electrolytic, membrane 46 located between an anode region 42 and a cathode region 44. Each region 42 and 44 includes an electrode 204, namely, an anode 206 and a cathode 208, respectively. Each region 42 and 44 also includes a support 210, such as a supporting plate 212. Support 210 may form a portion of the bipolar plate assemblies that are discussed in more detail herein. The supporting plates 212 of fuel cell 38 may carry, or conduct, the relative voltage potential produced by the fuel cell.

In operation, hydrogen gas 28 from supply 48 is delivered to the anode region, and air (and/or oxygen) 32 from supply 50 is delivered to the cathode region. Hydrogen and oxygen gases may be delivered to the respective regions of the fuel cell via any suitable mechanism from respective sources 48 and 50.

Hydrogen gas and oxygen gas typically react with one another via an oxidation-reduction reaction. Although electrolytic membrane 46 restricts the passage of a hydrogen molecule (a fuel molecule), it will permit a hydrogen ion (proton) to pass through it, largely due to the ionic conductivity of the membrane. The free energy of the oxidation-reduction reaction drives the proton from the hydrogen gas through the barrier. As membrane 46 also tends not to be electrically conductive, an external circuit 214 is the lowest energy path for the remaining electron. In cathode region 44, electrons from the external circuit and protons from the membrane combine with oxygen to produce water and heat.

Also shown in FIG. 6 are an anode purge, or exhaust, stream 216, which may contain hydrogen gas, and a cathode air exhaust stream, or cathode purge stream, 218, which is typically at least partially, if not substantially, depleted of oxygen. Anode purge stream 216 may also include other components, such as nitrogen gas, water, and other gases that are present in the hydrogen gas or other fuel stream that is delivered to the anode region. Cathode purge stream 218 will typically also include water. Fuel cell stack 24 may include a common hydrogen (or other reactant/fuel) feed, air intake, and stack purge and exhaust streams, and accordingly will include suitable fluid conduits to deliver the associated streams to, and collect the streams from, the individual fuel cells. Similarly, any suitable mechanism may be used for selectively purging the regions. It is also within the scope of the present disclosure that the hydrogen gas stream that is delivered to the anode region as a fuel stream may be (but is not required to be) recycled (via any suitable mechanism and/or via a suitable recycle conduit from the anode region) to reduce the amount of hydrogen gas that is wasted or otherwise exhausted in anode purge stream 216. As an illustrative, non-exclusive example, the hydrogen gas in the anode region may be recycled for redelivery to the anode region via a recycle pump and an associated recycle conduit. In such an embodiment, the recycle pump may draw hydrogen gas from the anode region of a fuel cell (or fuel cell stack) and redeliver the recycled hydrogen gas via the recycle conduit to the anode region of the fuel cell (and/or a different fuel cell or fuel cell stack).

In practice, fuel cell stack 24 may include a plurality of fuel cells with bipolar plate assemblies or other suitable supports separating adjacent membrane-electrode assemblies. The supports may permit the free electron to pass from the anode region of a first cell to the cathode region of the adjacent cell via the bipolar plate assembly, thereby establishing an electrical potential through the stack. This electrical potential may create a net flow of electrons that produces an electric current, which may be used to satisfy an applied load, such as from an energy-consuming device 36.

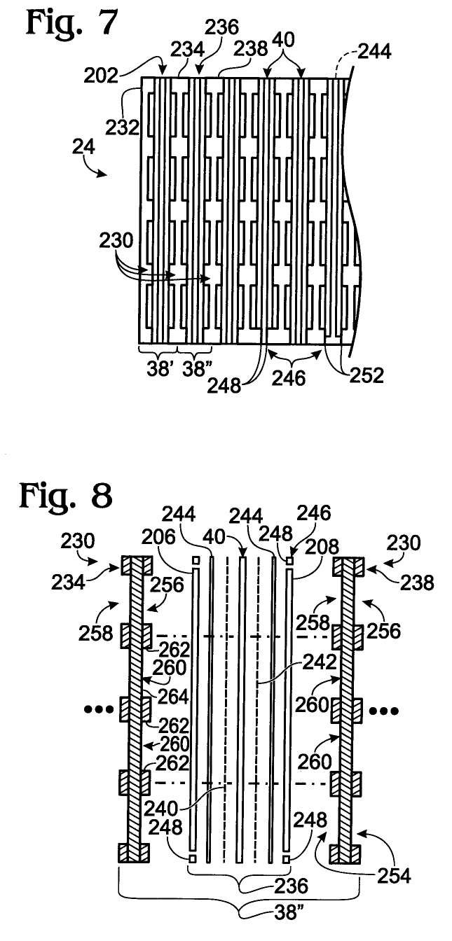

FIG. 7 shows a schematic representation of a fragmentary portion of an illustrative, non-exclusive example of a fuel cell stack 24. As shown, the illustrated portion includes a plurality of fuel cells, including fuel cells 38′ and 38″. Fuel cell 38′ includes a membrane-electrode assembly (MEA) 202 positioned between a pair of bipolar plate assemblies 230, such as assemblies 232 and 234. Similarly, fuel cell 38″ includes an MEA 236 positioned between a pair of bipolar plate assemblies 232, such as bipolar plate assemblies 234 and 238. Therefore, bipolar plate assembly 234 is operatively interposed between adjacently situated MEAs 202 and 236. Additional fuel cells may be serially connected in similar fashion, wherein a bipolar plate may be operatively interposed between adjacent MEAs. The phrase “working cell” is used herein to describe fuel cells, such as cells 38′ and 38″, that are configured to produce electric current and typically include an MEA positioned between bipolar plate assemblies.

FIG. 8 shows an exploded schematic view of an illustrative fuel cell, or fuel cell assembly, 38″, which as discussed includes a membrane-electrode assembly (MEA) 236 positioned between bipolar plate assemblies 234 and 238. MEA 236 includes anode 206, cathode 208, and an electron barrier 40 that is positioned therebetween.

For at least PEM fuel cells, the electrodes, such as anode 206 and cathode 208, may be constructed of a porous, electrically conductive material such as carbon fiber paper, carbon fiber cloth, or other suitable materials. Catalysts 240 and 242 are schematically depicted as being disposed between the electrodes and the electron barrier. Such catalysts facilitate electrochemical activity and are typically embedded into barrier 40, such as into membrane 46. Cell 38″ will typically also include a gas diffusion layer 244 between the electrodes and catalysts 240 and 242. For example, layer 244 may be formed on the surface of the electrodes and/or the catalysts and may be formed from a suitable gas diffusing material, such as a thin film of powdered carbon. Layer 244 may be treated to be hydrophobic to resist the coating of the gas diffusion layers by water present in the anode and cathode regions, which may prevent gas from flowing therethrough.

A fluid seal may be formed between adjacent bipolar plate assemblies. As such, a variety of sealing materials or sealing mechanisms 246 may be used at or near the perimeters of the bipolar plate assemblies. An example of a suitable sealing mechanism 246 is a gasket 248 that extends between the outer perimeters of the bipolar plate assemblies and barrier 40. Other illustrative examples of suitable sealing mechanisms 246 are schematically illustrated in the lower portion of FIG. 8 and include bipolar plate assemblies with projecting flanges, which extend into contact with barrier 40, and/or a barrier 40 with projecting flanges 252 (see FIG. 7) that extend into contact with the bipolar plate assemblies. In some embodiments, such as graphically depicted in FIG. 8, the cells to include a compressible region between adjacent bipolar plate assemblies, with gaskets 248 and barrier 40 being examples of suitable compressible regions that permit the cells, and thus the stack, to be more tolerant and able to withstand external forces applied thereto.

As shown in FIG. 8, bipolar plate assemblies 234 and 238 extend along opposite sides of MEA 236 so as to provide structural support to the MEA. Such an arrangement also allows the bipolar plate assemblies to provide a current path between adjacently situated MEAs. Bipolar plate assemblies 234 and 238 are shown with flow fields 254, namely anode flow fields 256 and cathode flow fields 258. Flow field 256 is configured to transport fuel, such as hydrogen gas, to the anode. Similarly, flow field 258 is configured to transport oxidant, such as oxygen gas, to the cathode and to remove water and heat therefrom. The flow fields also provide conduits through which the exhaust or purge streams may be withdrawn from the fuel cell assemblies. The flow fields typically include one or more channels 260 that are at least partially defined by opposing sidewalls 262 and a bottom, or lower surface 264. Flow fields 256 and 258 have been schematically illustrated in FIG. 8 and may have a variety of shapes and configurations. Similarly, the channels 260 in a given flow field may be continuous, discontinuous, or may contain a mix of continuous and discontinuous channels. Examples of a variety of flow field configurations are shown in U.S. Pat. Nos. 4,214,969, 5,300,370, and 5,879,826, the complete disclosures of which are herein incorporated by reference for all purposes.

As also shown in FIG. 8, the bipolar plate assemblies may include both anode and cathode flow fields, with the flow fields being generally opposed to each other on opposite faces of the bipolar plate assemblies. This construction enables a single bipolar plate assembly 230 to provide structural support and contain the flow fields for a pair of adjacent MEAs. For example, as illustrated in FIG. 8, bipolar plate assemblies 234 and 238 each include an anode flow field 256 and a cathode flow field 258. Although many, if not most or even all, of the bipolar plate assemblies within a stack will have the same or a similar construction and application, it is within the scope of the disclosure that not every bipolar plate assembly within stack 24 contains the same structure, supports a pair of MEAs, or contains oppositely facing flow fields.

FIG. 9 shows a schematic view of an example 280 of an illustrative fuel cell system 20. Fuel cell system 280 may include at least one fuel cell stack 24 with fuel cells 38 that may each include a proton exchange membrane 46. System 280 also may have distinct configurations for generating electrical output and for fuel cell hydration, as described herein.

Fuel cell system 280 may include a reactant delivery system 31 that includes a fuel supply system 282 and an oxidant supply system 284 that respectively deliver hydrogen gas 28 and air (or other suitable oxygen-containing gas) 32 to fuel cell stack 24. Supply systems 282 and 284 may be operatively coupled to control system 74 such that controller 170 controls placement, or configuring, of the fuel cell system into at least a power-generating configuration, a hydrating configuration, and an idle configuration.

Fuel supply system 282 is adapted to deliver hydrogen gas or another suitable fuel from any suitable fuel source 286, such as those described, illustrated, and/or incorporated herein. As illustrated in FIG. 9, the fuel source (such as a hydrogen-generating fuel processor and/or hydrogen-storage device) may be fluidly connected to the anode regions 42 of the fuel cell stack by a conduit assembly 52 that includes one or more fuel supply conduits 56. Fuel flow through fuel supply conduit(s) 56 may be regulated by flow-management devices 162, such as supply tank valve 288, regulator valve 290, and switch valve 292. In illustrative embodiments, the supply tank valve may be operable to alternatively permit or block flow of fuel from tank 286. In addition, the regulator valve may be operable to adjust the flow rate over a continuous range (or only discrete values within the range). Furthermore, switch valve 292 may be operable to direct the fuel to either anode regions 42 or to cathode regions 44, according to whether fuel cell stack 24 is providing electrical output or being hydrated without electrical output. In some embodiments, the switch valve may be at least a three-way valve.

Fuel supply system 282 may optionally also include a recirculation assembly 294 that recirculates fuel through the fuel cell stack, generally to increase the percentage of fuel that is used by the fuel cell stack (and/or to decrease the amount of fuel that is vented to the environment). The recirculation assembly may include at least one pump 296 or other drive mechanism (fluid propulsion mechanism). In addition, the recirculation assembly may be vented via a purge valve 298 disposed downstream of the fuel cell stack.

Oxidant supply system 284 may deliver air from the ambient environment or other suitable source to anode regions 44 of fuel cell stack 24. The oxidant supply system thus may include an intake region or entry port 300 through which air enters the fuel cell system and one or more supply conduits 60 that carry the air to fuel cell stack 24. The oxidant supply system may drive air through supply conduit(s) 60 via a fluid propulsion mechanism 302, such as a blower 304. The air optionally may be filtered by a filter 306 disposed upstream or downstream of blower 304. In addition, oxidant supply system 284 may include an upstream temperature sensor 308 that measures the temperature of the air before the air enters the fuel cell stack, and also may include a humidifier 310 that humidifies the air.

Oxidant supply system 284 optionally may include a recirculation assembly 312 that recirculates air through the fuel cell stack or other portion of fuel cell system 280. When present, recirculation assembly 312 may include at least one pump or other fluid propulsion mechanism or may rely upon upstream fluid propulsion mechanism 302 to drive fluid flow. In addition, the recirculation assembly may include a downstream temperature sensor 314 that measures the temperature of the air after the air leaves the fuel cell stack.

As an illustrative, non-exclusive example, fuel cell system 280 may be placed into a hydrating configuration by operation of switch valve 292. This operation may be under the control of controller 170, as indicated at 316. Fuel may be introduced into the oxidant supply system at any suitable position upstream of the fuel cell stack (or downstream if the system recirculates oxidant). For example, the fuel may be introduced upstream of the blower 304, such as into a port near the blower.

The hydrating configuration may have any suitable flow rate of fuel. For example, the flow rate of fuel into the oxidant supply system (to provide mixing of fuel and oxidant) may be restricted by a bleed valve 318 or other flow control device. In some embodiments, the amount of fuel combined with the oxidant may be determined, at least in part, by a cross-sectional area and/or dimension at a position(s) along a branch path 320 that brings the fuel into contact with the oxidant. For example, reducing the cross-sectional area and/or diameter of the branch path at a restriction point 322 may create a passive orifice 323 that provides a corresponding reduction in flow rate of the fuel. In some embodiments, the cross-sectional area and/or diameter may be selected such that the fuel bleeds into the oxidant supply system at a flow rate that is much less than the rate at which fuel is delivered during generation of electrical output. For example, the fuel may be delivered to the oxidant supply system and/or fuel cell stack at a flow rate that is substantially less than its corresponding flow rate for delivery to the fuel cell stack, for example, at least about 5, 10, 50, or 100 times less. If delivered through an orifice, the orifice may, for example, have a diameter of less than about 0.010 or 0.005 inches, among others.

In some embodiments, the nominal flow rate of oxidant may be fixed, or predetermined. Additionally, or alternatively, a suitable flow rate of the oxidant may be selected by adjusting the operating speed of an oxidant propulsion mechanism (e.g., a blower), or the flow rate may be the same as for generation of electrical output. In some embodiments, the blower speed for a hydration cycle may be selected such that, in combination with the flow rate of the fuel, the mixture of fuel and oxidant becomes saturated or near saturated with water when the fuel and oxidant react in the fuel cell stack. In other words, the amount of water produced may be sufficient to place the oxidant stream near or above 100% humidity, such as at least about 60% or 80% relative humidity. The oxidant and/or fuel flow rate also or alternatively may be selected or adjusted such that the fuel cell stack, and particularly the membrane electrode assemblies, do not heat up significantly during a hydration cycle. In any event, fuel and oxidant may be mixed in a ratio that is below the lower flammability limit (LFL) of the fuel. The ratio may be below the lower flammability limit of the fuel at the point of mixing or downstream of the fuel cell stack. The mixture thus may be subflammable to avoid combustion, that is, less than about 100%, 75%, 50%, or 25%, among others, of the lower flammability limit of the fuel, and optionally may produce less than about 100 watts. Illustrative ratios that may be suitable include a fuel dilution via oxidant of at least about 10, 25, or 50 fold.

Temperature generally determines how much water corresponds to 100% humidity. In particular, air (or oxidant) is capable of holding more water vapor as the temperature of the air increases. Accordingly, with increased temperature, more water may need to be formed during a hydration cycle to achieve effective hydration of the fuel cell stack, since a greater percentage of the water formed leaves the fuel cell stack as water vapor. Hydration thus may be performed more efficiently at a relatively lower temperature. As a result, the controller may be adapted to start a hydration cycle only if a measured temperature of the fuel cell system or ambient environment is below a threshold temperature, such as below about 25, 20, or 18° C. In some embodiments, the flow rate of fuel and/or oxidant may be adjusted according to the measured temperature, such that more effective hydration is achieved. Alternatively, or in addition, the fuel cell system may cool (see below) at least a portion of the fuel cell system such that less of the water generated is lost as water vapor.

Fuel cell system 280 also may, but is not required to, include a thermal management system 324. System 324 may be adapted to regulate the temperature of any suitable portion of fuel cell system 280, for example, maintaining the fuel cell stack within a predetermined, or selected, operating temperature range, such as below a maximum threshold temperature, and/or above a minimum threshold temperature. Thermal management system 324 thus may include a cooling mechanism 326 and/or a heating mechanism 328. In the illustrative embodiment presented here, system 324 utilizes a fluid (such as a liquid), e.g., coolant 330, that is propelled around a flow circuit 332 by a pump 334. The coolant flows through and/or around fuel cell stack 24, to provide cooling and/or heating of the fuel cell stack. Flow circuit 332 may (but is not required to) include a thermostatic valve 336 that operates to direct coolant 330 into the proximity of cooling mechanism 326 (and/or heating mechanism 328), for heat transfer, or to divert coolant 330 away from the cooling/heating mechanism via detour(s) 338, according to the temperature of the coolant. Thermostatic valve 336 also may operate to divert coolant 330 through a filter 340, such as a de-ionizing cartridge 342. Any suitable cooling mechanism and/or heating mechanism may be used in the fuel cell system. For example, here, the cooling mechanism includes a radiator 344 and at least one fan 346. In other embodiments, the cooling mechanism may include a refrigerating compressor, a Peltier device, a fan or blower, etc. Illustrative heating mechanisms may include a resistive heater, a combustion heater (e.g., a gas heater), an infrared lamp, a Peltier device, or the like. The temperature of the thermal control system may be measured by a temperature sensor 348. An illustrative, non-exclusive example of suitable thermal management systems are disclosed in U.S. Patent Application Publication No. 2007/0042247, the complete disclosure of which is hereby incorporated by reference.

### INDUSTRIAL APPLICABILITY

The fuel cell systems disclosed herein are applicable to the energy-production industries, and more particularly to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A fuel cell system with maintenance hydration during periods of inactivity, the fuel cell system comprising:
at least one fuel cell including an anode region, a cathode region, and an electrolytic barrier that permits selective movement of positive charge between the anode region and the cathode region;
a reactant delivery system for directing a fuel and an oxidant to the at least one fuel cell, the reactant delivery system including a conduit assembly having (1) a first configuration that directs the fuel to the anode region and the oxidant to the cathode region for generation of electrical output, and (2) a second configuration that directs both the fuel and the oxidant to the anode region, to the cathode region, or both to the anode region and to the cathode region, to generate water; and
a controller operatively coupled to the reactant delivery system and adapted to control configuring of the conduit assembly into the second configuration such that the at least one fuel cell is hydrated without generation of electrical output.

2. The fuel cell system of claim 1, wherein the reactant delivery system includes a valve that selects whether the fuel is directed to the anode region or the cathode region, and wherein the controller controls operation of the valve.

3. The fuel cell system of claim 1, wherein the controller is configured to control configuring of the conduit assembly into the second configuration based at least in part on at least one measured characteristic of the fuel cell system, of the environment near the fuel cell system, or of both, and wherein the at least one measured characteristic corresponds to temperature, humidity, hydration, or a combination thereof.

4. The fuel cell system of claim 1, further comprising a timer mechanism in communication with the controller, wherein the controller is configured to control configuring of the conduit assembly into and/or out of the second configuration at least in part according to one or more time values measured by the timer mechanism.

5. The fuel cell system of claim 1, further comprising a hydration sensor in communication with the controller, the controller being configured to control configuring of the conduit assembly into and/or out of the second configuration at least in part according to a level of hydration measured by the hydration sensor.

6. The fuel cell system of claim 5, wherein the hydration sensor measures an impedance of the at least one fuel cell.

7. The fuel cell system of claim 1, further comprising a sensor that measures an ambient condition, the sensor being in communication with the controller such that the controller controls configuring of the conduit assembly into and/or out of the second configuration based, at least in part, on the ambient condition measured by the sensor.

8. The fuel cell system of claim 1, wherein the controller is configured to control automatic configuring of the conduit assembly into the second configuration responsive to at least a predetermined time period elapsed since the at least one fuel cell was in the first or the second configuration.

9. The fuel cell system of claim 1, wherein the first and second configurations provide distinct rates of flow of the fuel to the at least one fuel cell, and wherein the rate of flow with the second configuration is substantially less than the rate of flow with the first configuration.

10. The fuel cell system of claim 1, further comprising a drive mechanism that propels the oxidant along the conduit assembly, wherein the drive mechanism is in communication with the controller such that the controller controls operation of the drive mechanism to provide distinct rates of oxidant flow when the conduit assembly is in the first and second configurations.

11. The fuel cell system of claim 1, wherein the at least one fuel cell is a hydrogen fuel cell that generates electrical output by converting hydrogen and oxygen to water.

12. The fuel cell system of claim 1, further comprising a stack of fuel cells including the at least one fuel cell.

13. A method of hydrating a fuel cell system including at least one fuel cell having an anode region, a cathode region, and an electrolytic barrier that permits selective movement of positive charge between the anode region and the cathode region for generation of electrical output, the method comprising:
delivering both a fuel and an oxidant to the anode region, the cathode region, or both to the anode region and to the cathode region, such that the fuel and the oxidant are in contact with each other and react to increase hydration of the at least one fuel cell without generating electrical output.

14. The method of claim 13, wherein the step of delivering includes a step of delivering a predefined ratio of a fuel and an oxidant.

15. The method of claim 13, wherein the fuel is hydrogen, and wherein the electrolytic barrier is a proton exchange membrane.

16. The method of claim 13, further comprising a step of combining the fuel and the oxidant before the step of delivering.

17. The method of claim 16, wherein the step of combining includes a step of combining the fuel and the oxidant at less than the lower flammability limit (LFL) of the fuel.

18. The method of claim 13, further comprising a step of generating electrical output by supplying the fuel to the anode region and the oxidant to the cathode region such that the fuel and the oxidant are separated from each other by the electrolytic barrier.

19. The method of claim 13, wherein the step of delivering is performed after a period of inactivity during which the at least one fuel cell did not generate electrical output.

20. The method of claim 19, further comprising a step of selecting a time for starting the step of delivering based at least in part on a predefined period of inactivity for the at least one fuel cell.

21. The method of claim 13, wherein the step of delivering is performed periodically.

22. The method of claim 13, further comprising a step of measuring a characteristic corresponding to a level of hydration of the fuel cell system, and a step of selecting a time for starting the step of delivering based at least in part on the measured characteristic.

23. The method of claim 13, further comprising a step of measuring ambient temperature or ambient humidity, and a step of selecting a time for starting the step of delivering based at least in part on the ambient temperature or ambient humidity measured.

24. The method of claim 23, wherein the step of selecting a time includes a step of selecting a time for which the ambient temperature is below a predefined threshold temperature.

25. The method of claim 13, wherein the step of delivering is started automatically.

26. The method of claim 13, further comprising a step of supplying a fuel to the anode region and an oxidant to the cathode region for generation of electrical output.

27. The method of claim 26, wherein the fuel has a flow rate, and wherein the flow rate for the step of delivering is substantially less than the flow rate for the step of supplying.

28. The method of claim 26, wherein the oxidant has a flow rate, and wherein the flow rate for the step of delivering is different than the flow rate for the step of supplying.

29. A method of operating a fuel cell system having at least one fuel cell with an anode region, a cathode region, and an electrolytic barrier that permits selective movement of positive charge between the anode region and the cathode region for generation of electrical output, the method comprising:
generating electrical output by disposing a fuel in the anode region and an oxidant in the cathode region; and
hydrating the at least one fuel cell by (1) mixing the fuel and the oxidant to form a mixture, and (2) disposing the mixture in the cathode region, in the anode region, or both in the cathode region and in the anode region, to produce water.

30. The method of claim 29, wherein the step of hydrating is performed after a period of inactivity during which the step of generating was not performed.

31. The method of claim 30, wherein the step of hydrating is performed after a predefined period of inactivity has elapsed.

32. The method of claim 29, wherein the step of hydrating is started automatically.

33. The method of claim 29, wherein the step of hydrating does not generate electrical output.
